(19) United States
(12) Patent Application Publication
(10) Pub. No.: US 2017/0197601 A1
(43) Pub. Date: Jul. 13, 2017

(54) HYDRAULIC UNIT FOR A BRAKE SYSTEM OF A VEHICLE, AND METHOD FOR PRODUCING A HYDRAULIC UNIT FOR A BRAKE SYSTEM OF A VEHICLE

(71) Applicant: Robert Bosch GmbH, Stuttgart (DE)

(72) Inventor: Patrick Christian SCHAEFER, Ludwigsburg (DE)

(21) Appl. No.: 15/314,836

(22) PCT Filed: Apr. 23, 2015
(86) PCT No.: PCT/EP2015/058823

§ 371 Date: Nov. 29, 2016

(30) Foreign Application Priority Data
Jun. 18, 2014 (DE) 10 2014 211 761.5

(51) Int. Cl. B60T 13/14; B60T 7/06; B60T 11/22

(52) U.S. Cl. CPC B60T 13/142; B60T 11/22; B60T 7/06; B60T 13/147; B60Y 2306/09

(57) ABSTRACT

A hydraulic assemblage for a braking system of a vehicle, including a brake master cylinder and at least one valve, the brake master cylinder being disposed in and/or on a first hydraulic assemblage sub-block, and the at least one valve being disposed in and/or on a second hydraulic assemblage sub-block; the first hydraulic assemblage sub-block and the second hydraulic assemblage sub-block being joined to one another via an interlayer that is shaped at least in part from at least one airtight material having vibration-damping properties; and at least one first conduit portion of the first hydraulic assemblage sub-block being connected, via at least one hydraulic connecting structure extending through the interlayer, to at least one second conduit portion of the second hydraulic assemblage sub-block. A braking system for a vehicle, having a hydraulic assemblage and a method for manufacturing a hydraulic assemblage for a braking system are also described.

### FIELD

The present invention relates to a hydraulic assemblage for a braking system of a vehicle and to a braking system of a vehicle having a hydraulic assemblage. The present invention further relates to a method for manufacturing a hydraulic assemblage for a braking system of a vehicle.

### BACKGROUND INFORMATION

Hydraulic assemblages for a braking system of a vehicle, for example the VW 6 Q0614117R 6Q0907379 AA ABS hydraulic braking assemblage of Bosch (having the item number 0265231434 0265800363), are available. FIG. 1 schematically depicts a conventional hydraulic assemblage of this kind.

Hydraulic assemblage 10 according to the existing art, depicted schematically in FIG. 1, has a hydraulic block/hydraulic assemblage block 12 in which at least one valve (not illustrated) and at least one pump (not depicted) are disposed. An electric motor 14 that can be used to operate the at least one pump of hydraulic block 12 is fastened on hydraulic block 12. In addition, a control unit 16 for applying control to the at least one valve and to the at least one pump is likewise disposed on hydraulic block 12. At least one further component of a braking system equipped with the conventional hydraulic assemblage 10, for example a brake master cylinder and/or a brake fluid reservoir, can be linked via at least one connecting conduit 18 to hydraulic block 12.

### SUMMARY

The present invention provides a hydraulic assemblage for a braking system of a vehicle, a braking system for a vehicle, and a method for manufacturing a hydraulic assemblage for a braking system of a vehicle.

The present invention provides hydraulic assemblages that combine at least one brake master cylinder and at least one valve in a compact configuration. Each hydraulic assemblage according to the present invention thus has the advantage that upon installation of the hydraulic assemblage on/in a braking system/vehicle, no conduits, cables, or holders for connecting the brake master cylinder to the at least one valve of the hydraulic assemblage are needed. As discussed in further detail below, a hydraulic assemblage according to the present invention can also encompass at least one further braking system component, so that conduits, cables or holders for connection to other components of the hydraulic assemblage likewise are not needed for the installation thereof.

In addition, despite integration of the brake master cylinder and the at least one valve into the hydraulic assemblage, mounting of the brake master cylinder close to the brake pedal can easily be accomplished without transferring to a vibration-transferring component of the vehicle body a pressure equalization shock triggered by switching of the at least one valve. As will be described in further detail below, the hydraulic assemblage can in particular be bolted onto a vehicle wall component/firewall of the vehicle, transfer of a pressure equalization shock to the vehicle wall component/firewall at the same time being prevented by way of the interlayer. A driver of a vehicle equipped with a hydraulic assemblage according to the present invention thus perceives (almost) no noise or vibration even in the event of a pressure equalization shock. Equipping the vehicle with the hydraulic assemblage according to the present invention is thus associated with a large increase in convenience.

It is noted that the advantageous dampability of a pressure equalization shock by way of the interlayer of a hydraulic assemblage according to the present invention is independent of a design or a type of the at least one valve of the hydraulic assemblage. Equipping the hydraulic assemblage with complex and expensive special valves as a noise mitigation measure can thus be omitted. The present invention thus also contributes to reducing manufacturing costs for a hydraulic assemblage having a brake master cylinder and at least one valve.

Advantageously, the first hydraulic assemblage sub-block and the second hydraulic assemblage sub-block are integrated with one another in positively fitting fashion by way of the interlayer. The first hydraulic assemblage sub-block and the second hydraulic assemblage sub-block are thus joined together by way of the interlayer in such a way that they can easily be installed together as one compact component.

For example, the first hydraulic assemblage sub-block and/or the second hydraulic assemblage sub-block can be a cast part and/or an extruded part. The first hydraulic assemblage sub-block and/or the second hydraulic assemblage sub-block are thus manufacturable in simple fashion using conventional processes.

In particular, the first hydraulic assemblage sub-block and/or the second hydraulic assemblage sub-block can be formed at least in part from aluminum and/or an aluminum alloy. Inexpensive and easily processable materials are thus usable for manufacturing the first hydraulic assemblage sub-block and the second hydraulic assemblage sub-block. It is noted here, however, that the manufacturability of the first hydraulic assemblage sub-block and of the second hydraulic assemblage sub-block is not limited to the use of a specific material.

In an advantageous embodiment the interlayer encompasses at least one adhesive as the at least one airtight material. The at least one airtight material can thus already be used for the desired connection of the first hydraulic assemblage sub-block to the second hydraulic assemblage sub-block. Securing of the connection, for example by way of at least one pin, at least one bolt, and/or at least one screw, is thus merely optional. In addition, many adhesives are easily deformable in order to form the at least one hydraulic connecting structure extending through the interlayer. At the same time, many adhesives are water-resistant and airtight. It is noted, however, that the use of an adhesive as the at least one airtight material can also be omitted.

In a further advantageous embodiment at least one pump having at least one pump motor is disposed on and/or in the second hydraulic assemblage sub-block. As a supplement or alternative thereto, at least one control unit can also be disposed on and/or in the second hydraulic assemblage sub-block. In such a case noise or vibration of the at least one pump, of the at least one pump motor, and/or of the at least one control unit can once again reliably be absorbed by way of the interlayer, so there is no risk of transferring noise or vibration from the second hydraulic assemblage sub-block to the first hydraulic assemblage sub-block.

In a further advantageous embodiment an input rod or pedal rod, to which a brake pedal is directly or indirectly linkable or linked, projects partly out of the first hydraulic assemblage sub-block. A driver braking force exerted on the brake pedal is thus reliably transferable to at least one displaceable piston of the brake master cylinder of the first hydraulic assemblage sub-block. The driver can thus easily apply braking directly into the brake master cylinder, while at the same time there is no risk of transferring vibration or noise from the second hydraulic assemblage sub-block to a vehicle wall component/firewall disposed adjacently to the brake master cylinder and to the first hydraulic assemblage sub-block.

In an advantageous refinement a pedal travel sensor is disposed in and/or on the first hydraulic assemblage sub-block. As an alternative or supplement to the pedal travel sensor, a brake booster such as a vacuum brake booster (negative-pressure brake booster) or an electromechanical brake booster can also be disposed in and/or on the first hydraulic assemblage sub-block. An actuation of the brake pedal linked to the input rod or to the pedal rod can thus reliably be detected by way of the pedal travel sensor and/or can be assisted by way of the brake booster.

An adapter plate boltable onto a vehicle wall component of the respective vehicle is preferably fastened on the first hydraulic assemblage sub-block. The hydraulic assemblage can thus be fastened in simple fashion on the vehicle wall component, for example a firewall, in such a way that the driver can conveniently apply braking into the brake master cylinder of the first hydraulic assemblage sub-block. At the same time, transfer of noise and/or vibration to the respective vehicle wall component is reliably suppressed by way of the interlayer, even in the context of a pressure equalization shock due to switching of the at least one valve of the second hydraulic assemblage sub-block.

In addition, at least one hydraulic linking structure, to which a brake fluid reservoir is hydraulically linkable or linked, can be configured on an outer wall of the first hydraulic assemblage sub-block. The hydraulic assemblage having the brake fluid reservoir linked thereto can thus be easily installed as a compact unit on a vehicle.

The advantages described above are also ensured in the context of a braking system for a vehicle having a hydraulic assemblage of this kind.

Execution of the corresponding method for manufacturing a hydraulic assemblage for a braking system of a vehicle also creates the above-described advantages. The manufacturing method can be refined in accordance with the above-described respective embodiments of the hydraulic assemblage and of the braking system equipped therewith.

In an advantageous embodiment of the manufacturing method, a preform of the first hydraulic assemblage sub-block or the first hydraulic assemblage sub-block, and a preform of the second hydraulic assemblage sub-block or the second hydraulic assemblage sub-block, are over-molded, adhesively bonded, or vulcanized with the at least one airtight material. The intermediate component produced by overmolding, adhesive bonding, or vulcanizing can then be treated as a single component for the execution of further method steps of the manufacturing method.

In an alternative embodiment of the manufacturing method, at least one initial form of the interlayer is formed on the at least one airtight material as a separate part, over which the preform of the first hydraulic assemblage sub-block or the first hydraulic assemblage sub-block, and the preform of the second hydraulic assemblage sub-block or the second hydraulic assemblage sub-block, are then joined to one another. In particular, the interlayer can in this case easily be manufactured as a finished part having the at least one hydraulic connecting structure configured therein.

### BRIEF DESCRIPTION OF THE DRAWINGS

Further features and advantages of the present invention are explained below with reference to the Figures.

FIG. 1 schematically depicts a conventional hydraulic assemblage.

FIG. 2 schematically depicts an embodiment of the hydraulic assemblage.

FIG. 3 is a flow chart to explain a first embodiment of the method for manufacturing a hydraulic assemblage for a braking system of a vehicle.

FIG. 4 is a flow chart to explain a second embodiment of the method for manufacturing a hydraulic assemblage for a braking system of a vehicle.

FIG. 5 is a flow chart to explain a third embodiment of the method for manufacturing a hydraulic assemblage for a braking system of a vehicle.

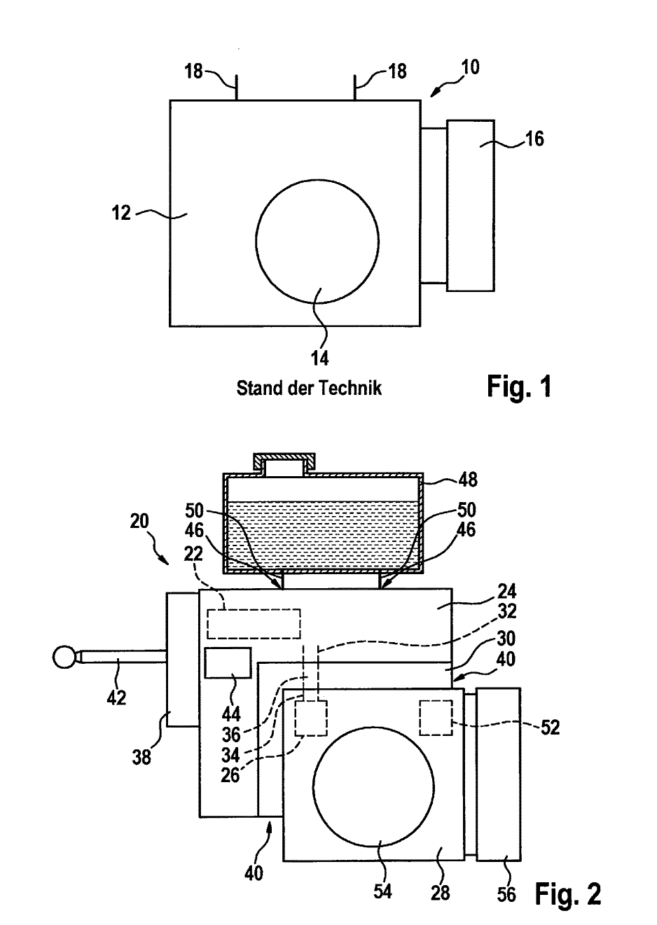

### DETAILED DESCRIPTION OF EXAMPLE EMBODIMENTS

FIG. 2 schematically depicts an embodiment of the hydraulic assemblage.

Hydraulic assemblage 20 depicted schematically in FIG. 2 is usable as a compact component/device in a braking system of a vehicle. As described in more detail below, hydraulic assemblage 20 can encompass all components of the braking system except for the wheel brake cylinders. Hydraulic assemblage 20 thus combines the functions of multiple components of the braking system as one compact component/device. Hydraulic assemblage 20 can therefore also be described as an “integrated braking system” (without wheel brake cylinders). It is noted that the usability of hydraulic assemblage 20, and of the braking system equipped therewith, is not limited to a specific vehicle type.

Hydraulic assemblage 20 encompasses a brake master cylinder 22 that is disposed in and/or on a first hydraulic assemblage sub-block 24. To paraphrase: brake master cylinder 22 is in direct contact with at least one material of first hydraulic assemblage sub-block 24 which at least partly surrounds it. Hydraulic assemblage 20 furthermore has at least one valve 26 that is disposed in and/or on a second hydraulic assemblage sub-block 28. A direct contact thus also exists between the at least one valve 26 and the at least one material of second hydraulic assemblage sub-block 28 which at least partly surrounds the respective valve 26.

Brake master cylinder 22 can be, for example a tandem brake master cylinder. It is noted, however, that the range of embodiment of first hydraulic assemblage sub-block 24 is not limited to a specific type of brake master cylinder. A plurality of different valve types can also be used for the at least one valve 26 of second hydraulic assemblage sub-block 28. The at least one valve 26 of second hydraulic assemblage sub-block 28 can be switchable by way of at least one electrical signal and/or by way of an applied pressure. The at least one valve 26 of second hydraulic assemblage sub-block 28 can be, for example, an isolation valve, a high-pressure valve, a switchover valve, a wheel inlet valve, a wheel outlet valve, a check valve, and/or an overpressure valve. The at least one valve 26 of second hydraulic assemblage sub-block 28 can therefore also be referred to as a valve of an ESP system and/or of an ABS system. The range of embodiment of second hydraulic assemblage sub-block 28 is not limited, however, to specific valve types for the at least one valve 26. The range of embodiment of second hydraulic assemblage sub-block 28 is also not limited to a specific number of valves.

First hydraulic assemblage sub-block 24 and second hydraulic assemblage sub-block 28 are joined to one another via an interlayer 30 that is formed at least in part from at least one airtight material having vibration-damping properties. Interlayer 30 can in particular be formed entirely from the at least one airtight material having vibration-damping properties. At least one first conduit portion 32 of first hydraulic assemblage sub-block 24 is connected, via at least one hydraulic connecting structure 36 extending through interlayer 30, to at least one second conduit portion 34 of second hydraulic assemblage sub-block 28. The at least one hydraulic connecting structure 36, which is integrated into the shape of interlayer 30, implements at least one hydraulic connection between the at least one first conduit portion 32 of first hydraulic assemblage sub-block 24 and the at least one associated second conduit portion 34 of second hydraulic assemblage sub-block 28. The at least one hydraulic connecting structure 36 is as a rule hydraulically and hermetically sealed.

The range of embodiment of interlayer 30 is not limited to a specific number of hydraulic connecting structures 36. The damping properties of interlayer 30, made of the at least one airtight material having vibration-damping properties, are (almost) independent of the number of hydraulic connecting structures 36 configured therein. Only one hydraulic connecting structure 36 is therefore schematically reproduced in FIG. 2.

It is also noted that a plurality of different types of brake circuits can be configured in first hydraulic assemblage sub-block 24, in second hydraulic assemblage sub-block 28, and in interlayer 30.

First hydraulic assemblage sub-block 24 and second hydraulic assemblage sub-block 28 are joined to one another by way of interlayer 30 in such a way that they are installable as one compact component. At the same time, interlayer 30 enables shielding of first hydraulic assemblage sub-block 24 from vibrations that are generated or triggered on and/or in second hydraulic assemblage sub-block 28. In particular, a pressure equalization shock triggered by switching of the at least one valve 26 of second hydraulic assemblage sub-block 28 can be absorbed/damped by way of interlayer 30. First hydraulic assemblage sub-block 24 can thus be fastened (directly or indirectly) on a vehicle wall component with no need to accept a noise impact on occupants of the respective vehicle (due to transfer of noise or vibration via the vehicle wall component into a vehicle interior) after a pressure equalization shock triggered by way of the at least one valve 26 of second hydraulic assemblage sub-block 28. Despite its ease of installation in the respective vehicle, hydraulic assemblage 20 thus ensures an increase in comfort for the vehicle occupants, who seldom perceive noise or vibration. A vehicle having low noise, vibration, and harshness (NVH) values can therefore be manufactured easily and inexpensively by way of hydraulic assemblage 20.

Thanks to the above-described configuration of hydraulic assemblage 20, the low perceptibility of noise or vibration is not limited to the use of special valves in hydraulic assemblage 20. It is thus not necessary to equip hydraulic assemblage 20 with special valves for the at least one valve 26 of second hydraulic assemblage sub-block 28. Inexpensive valves 26 can instead be used on and/or in second hydraulic assemblage sub-block 28. Hydraulic assemblage 20 can thus be manufactured inexpensively.

An adapter plate 38 boltable onto a vehicle wall component (not illustrated) of the respective vehicle is preferably fastened (directly) to first hydraulic assemblage sub-block 24. (A direct contact can exist between the adapter plate 38 and at least one material of first hydraulic assemblage sub-block 24.) Hydraulic assemblage 20 can thus easily be fastened to the vehicle wall component, for example to a firewall. In particular, hydraulic assemblage 20 can be installed as a compact component (“one-box system”) on the vehicle wall/firewall and can be connected to an interacting brake pedal (not depicted). Advantageous conventional installation positions can also be used for hydraulic assemblage 20. At the same time, despite easily executed fastening/bolting of hydraulic assemblage 20 on the respective vehicle wall component, the latter (together with first hydraulic assemblage sub-block 24) can be shielded by way of interlayer 30 from noise or vibration generated/triggered in second hydraulic assemblage sub-block 28. Transfer of the noise or vibration to the vehicle wall component, and further transfer thereof via the vehicle wall component into the interior of the vehicle, is therefore (almost) precluded.

Preferably, first hydraulic assemblage sub-block 24 and second hydraulic assemblage sub-block 28 are integrated in positively fitting fashion with one another by way of interlayer 30. In particular, at least one gap 40 present between first hydraulic assemblage sub-block 24 and second hydraulic assemblage sub-block 28 can be completely filled by interlayer 30 and by the at least one hydraulic connecting structure 36.

In a preferred embodiment, first hydraulic assemblage sub-block 24 is embodied in valve-free fashion. Also preferred is an embodiment of hydraulic assemblage 20 in which, with the exception of the at least one hydraulic connecting structure 36 in interlayer 30, no tubes or conduits proceed between first hydraulic assemblage sub-block 24 and second hydraulic assemblage sub-block 28. A soft/vibration-damping connection between first hydraulic assemblage sub-block 24 and second hydraulic assemblage sub-block 28 can thus be formed even without a physical separation. A probability of coupling of vibration from second hydraulic assemblage sub-block 28 into first hydraulic assemblage sub-block 24 is thereby significantly decreased.

Interlayer 30 can encompass at least one adhesive as the at least one airtight material (having vibration-damping properties). Interlayer 30 is preferably formed entirely from the at least one adhesive. A plurality of adhesives are airtight, have a vibration-damping effect, are water-insoluble, and can be manufactured cheaply. A plurality of inexpensive materials can therefore be used to form the at least one interlayer 30. At the same time, an interlayer 30 formed at least in part from the at least one adhesive creates from itself a (fixed) connection between first hydraulic assemblage sub-block 24 and second hydraulic assemblage sub-block 28. Additional securing of the connection between first hydraulic assemblage sub-block 24 and second hydraulic assemblage sub-block 28 by way of at least one positively fitting structural element, for example at least one pin, at least one bolt, and/or at least one screw, is thus merely optional. In addition, working steps for fastening the at least one positively fitting structural element in the context of the manufacture of hydraulic assemblage 20 are superfluous when the at least one adhesive is used as the at least one airtight material (having vibration-damping properties).

First hydraulic assemblage sub-block 24 and/or second hydraulic assemblage sub-block 28 can be formed at least in part from aluminum and/or an aluminum alloy. In particular, first hydraulic assemblage sub-block 24 and/or second hydraulic assemblage sub-block 28 can be formed entirely from aluminum and/or the aluminum alloy. Further inexpensive materials, however, can likewise be used to form first hydraulic assemblage sub-block 24 and/or second hydraulic assemblage sub-block 28.

First hydraulic assemblage sub-block 24 and/or second hydraulic assemblage sub-block 28 can be a cast part and/or an extruded part. Conventional processes can thus also be executed in order to manufacture first hydraulic assemblage sub-block 24 and second hydraulic assemblage sub-block 28.

Advantageously, a pedal rod 42 (or an input rod), to which a brake pedal is directly or indirectly linkable or linked, projects partly out of first hydraulic assemblage sub-block 24. The brake pedal is thus linkable in simple fashion to brake master cylinder 22 of first hydraulic assemblage sub-block 24 in such a way that a driver braking force exerted on the brake pedal can be used to build up brake pressure in brake master cylinder 22. A braking system equipped/configured with hydraulic assemblage 20 is therefore designed to decelerate the vehicle by way of the driver braking force even after a vehicle electrical system failure.

In the embodiment of FIG. 2, a pedal travel sensor 44 is disposed (directly) in and/or on first hydraulic assemblage sub-block 24. Preferably a direct contact exists between pedal travel sensor 44 and the at least one material of first hydraulic assemblage sub-block 24 at least partly surrounding pedal travel sensor 44. In an advantageous refinement, at least one brake booster (not illustrated) can also be disposed on and/or in first hydraulic assemblage sub-block 24. (A direct contact can correspondingly also exist between the at least one material of first hydraulic assemblage sub-block 24 and the brake booster.) The brake booster can be, for example, a vacuum brake booster (negative pressure brake booster) or an electromechanical brake booster. The configuration range of first hydraulic assemblage sub-block 24 is not, however, limited to a specific type of brake booster.

In hydraulic assemblage 20 of FIG. 2, at least one hydraulic linking structure 46 is configured on an outer wall of first hydraulic assemblage sub-block 24, to which structure a brake fluid reservoir 48 is hydraulically linkable or linked (directly or via at least one conduit 50). The at least one hydraulic linking structure 46 can be, for example, an orifice, in particular a breather orifice of brake master cylinder 22.

At least one motor 54 can be disposed (directly) on and/or in second hydraulic assemblage sub-block 28. Shielding of first hydraulic assemblage sub-block 24 with respect to motor noise of the at least one motor 54 of second hydraulic assemblage sub-block 28 is possible, by way of interlayer 30, even if an inexpensive type of motor is used for the at least one motor 54 of second hydraulic assemblage sub-block 28. A brushless motor can also be used as the at least one motor 54 of second hydraulic assemblage sub-block 28.

At least one pump 52 having at least one pump motor 54 can be disposed (directly) on and/or in second hydraulic assemblage sub-block 28 of FIG. 2. In this case a direct contact preferably exists between the at least one pump 52/at least one pump motor 54 and the at least one material of second hydraulic assemblage sub-block 28. Shielding of first hydraulic assemblage sub-block 24, or of the vehicle wall component having adapter plate 38 bolted thereonto, from pump noises and/or pump vibrations generated upon operation of the at least one pump 52 having the at least one pump 54 is ensured in this case as well by way of interlayer 30. Noise/vibration generated upon operation of the at least one pump 52/at least one pump motor 54 can be at least partly absorbed by way of interlayer 30. There is therefore no/hardly any need to accept transmission of that noise/vibration to first hydraulic assemblage sub-block 24, or to the vehicle wall component having adapter plate 38 bolted thereonto. Even if inexpensive components for the at least one pump 52 and/or the at least one pump motor 54 are installed on and/or in second hydraulic assemblage sub-block 28, the vehicle occupants are not irritated by pump noises transmitted into the vehicle interior.

As an alternative or supplement to the at least one pump 52, at least one piston-cylinder device (e.g., a plunger) operable by way of the at least one motor 54 can also be disposed as a pressure varying device on and/or in second hydraulic assemblage sub-block 28. Hydraulic assemblage 20 can thus also be usable for hydraulic brake boosting. At least one pressure sensor/inlet pressure sensor (not illustrated) can furthermore be installed on and/or in first hydraulic assemblage sub-block 24 and/or second hydraulic assemblage sub-block 28.

As a further alternative or as a supplement, at least one simulator (not illustrated) (e.g., a pedal travel simulator or a pedal feel simulator) can also be disposed in hydraulic assemblage 20, specifically in second hydraulic assemblage sub-block 28. The simulator can be a (passive) spring-piston unit or a (passive) rubber element-piston unit. In particular, the at least one simulator can be capable of being blocked off by way of at least one valve with respect to first hydraulic assemblage sub-block 24 and/or the at least one pump/pressure varying device (plunger). Thanks to hydraulic decoupling of the first hydraulic assemblage sub-block, hydraulic assemblage 20 can thus also be usable as a power braking device.

In the embodiment of FIG. 2 at least one control device 56 is disposed (directly) on and/or in second hydraulic assemblage sub-block 28. A direct contact can exist between the at least one control device 56 and the at least one material of second hydraulic assemblage sub-block 28. Control can be applied by way of the at least one control device 56 to the at least one valve 26, to the at least one pump 52, to the at least one piston-cylinder device, and/or to the at least one pump motor 54. (The at least one control device 56 can therefore also have at least one valve driver and/or at least one pressure sensor terminal.) The at least one control device 56 can furthermore also be usable for controlling/reading out pedal travel sensor 44 and/or the brake booster. For this, the at least one control device 56 can be connected via a respective conduit to pedal travel sensor 44 and/or to the brake booster. An embodiment of hydraulic assemblage 20 having at most one conduit per pedal travel sensor 44 and/or brake booster is preferred. Alternatively, a contact can also be configured between the at least one control device 56 and first hydraulic assemblage sub-block 24. In this case the at least one control device 56 can at least partly cover both hydraulic assemblage sub-blocks 24 and 28. In supplementary fashion, a plug connector, for example an ECU plug connector, can also be configured on the at least one control device 56.

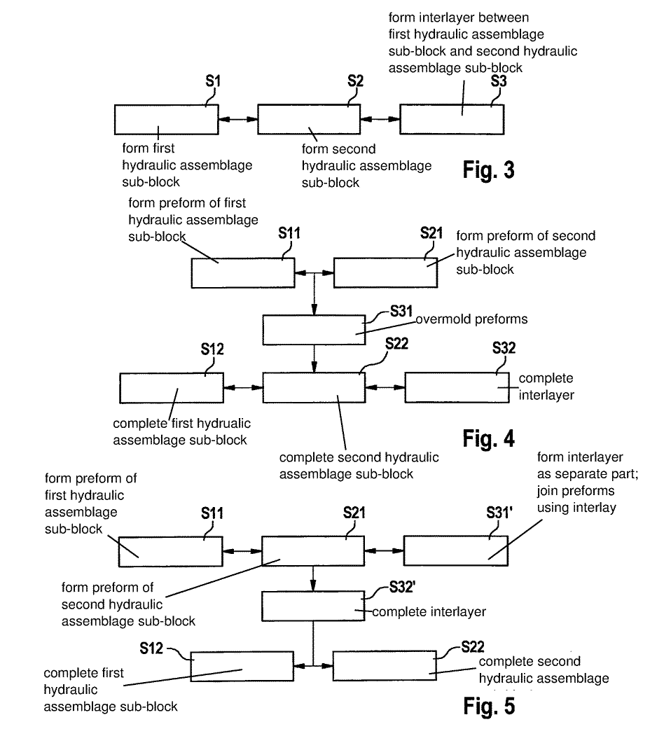

FIG. 3 is a flow chart to explain a first embodiment of the method for manufacturing a hydraulic assemblage for a braking system of a vehicle.

In a method step S1 a first hydraulic assemblage sub-block, having a brake master cylinder at least partly surrounded by the first hydraulic assemblage sub-block, is formed. In a method step S2 a second hydraulic assemblage sub-block, which is equipped with at least one valve at least partly surrounded by the second hydraulic assemblage sub-block, is also formed. Examples of a brake master cylinder usable upon execution of the method step S1, and of a valve usable for execution of the method step S2, have already been described above. The first hydraulic assemblage sub-block and/or the second hydraulic assemblage sub-block can each be manufactured, for example, as a cast part and/or as an extruded part.

In a further method step S3 an interlayer formed at least in part from at least one airtight material having vibration-damping properties is formed. The interlayer is shaped, and is disposed between the first hydraulic assemblage sub-block and the second hydraulic assemblage sub-block, in such a way that the first hydraulic assemblage sub-block and the second hydraulic assemblage sub-block are joined to one another via the interlayer, at least one first conduit portion of the first hydraulic assemblage sub-block being connected, via at least one connecting structure extending through the interlayer, to at least one second conduit portion of the second hydraulic assemblage sub-block.

The above-described method steps S1 to S3 can be executed in any sequence and/or at least partly simultaneously. Examples thereof are described below.

FIG. 4 is a flow chart to explain a second embodiment of the method for manufacturing a hydraulic assemblage for a braking system of a vehicle.

In the embodiment of FIG. 4, firstly a preform of the first hydraulic assemblage sub-block is formed in a sub-step S11 of the method step S1, and a preform of the second hydraulic assemblage sub-block is formed in a sub-step S21 of the method step S2. The preform of the first hydraulic assemblage sub-block and the preform of the second hydraulic assemblage sub-block are then, in a sub-step S31 of the method step S3, overmolded, adhesively bonded, or vulcanized with the at least one airtight material. Then the first hydraulic assemblage sub-block is completed in at least one further sub-step S12 of the method step S1, the second hydraulic assemblage sub-block is completed in at least one further sub-step S22 of the method step S2, and the interlayer is completed in at least one further sub-step S32 of the method step S3. During the sub-steps S12, S22, and S32 performed (in any sequence) for that purpose, the intermediate product can be treated as a single component. The costs incurred for executing the sub-steps S12, S33, and S32, and the work outlay necessary therefor, are therefore comparatively small.

In a variant of the manufacturing method described here, one of the method steps S1 and S2 can be completely executed before the sub-step S31. In this case, for example, in the sub-step S31 the (almost) complete first hydraulic assemblage sub-block and the (almost) complete second hydraulic assemblage sub-block can be overmolded, adhesively bonded, or vulcanized with the at least one airtight material. The manufacturing method can then be concluded by way of the sub-step S32.

FIG. 5 is a flow chart to explain a third embodiment of the method for manufacturing a hydraulic assemblage for a braking system of a vehicle.

In the manufacturing method described here, in a sub-step S31′ of the step S3 firstly at least one initial form of the interlayer is formed as a separate part from the at least one airtight material (having vibration-damping properties). In a further sub-step S32′ of the method step S3 the preform of the first hydraulic assemblage sub-block and the preform of the second hydraulic assemblage sub-block are then joined to one another via the part formed in the sub-step S31′. The sub-steps S12 and S22 can then also be executed. If only an initial form of the interlayer is shaped in the sub-step S31′, the interlayer can then be completed in a further sub-step (not illustrated) performed after the sub-step S32′. The complete interlayer can, however, already be used to perform the sub-step S32′. The at least one hydraulic connecting structure can thus already be introduced into the interlayer in the sub-step S31′.

In a modification of the manufacturing method described here, at least one of the method steps S1 and S2 can be completely executed before the sub-step S32′. In this case the first hydraulic assemblage sub-block and the second hydraulic assemblage sub-block can be joined to one another, for example in the sub-step S32′, via the part formed in the sub-step S31′.

The hydraulic assemblages obtained by way of the manufacturing methods described above also implement good decoupling of those components within an integrated braking system which are critical in terms of noise/vibration. The costs incurred for execution of the manufacturing methods are low.

1-15. (canceled)

16. A hydraulic assemblage for a braking system of a vehicle, comprising:
a brake master cylinder; and
at least one valve;
wherein the brake master cylinder is disposed at least one of in and on a first hydraulic assemblage sub-block, and the at least one valve is disposed at least one of in and on a second hydraulic assemblage sub-block, the first hydraulic assemblage sub-block and the second hydraulic assemblage sub-block being joined to one another via an interlayer that is shaped at least in part from at least one airtight material having vibration-damping properties, and at least one first conduit portion of the first hydraulic assemblage sub-block being connected, via at least one hydraulic connecting structure extending through the interlayer, to at least one second conduit portion of the second hydraulic assemblage sub-block.

17. The hydraulic assemblage as recited in claim 16, the first hydraulic assemblage sub-block and the second hydraulic assemblage sub-block are integrated to one another in positively fitting fashion by way of the interlayer.

18. The hydraulic assemblage as recited in claim 16, wherein at least one of the first hydraulic assemblage sub-block and the second hydraulic assemblage sub-block is at least one of a cast part and an extruded part.

19. The hydraulic assemblage as recited in claim 16, wherein at least one of the first hydraulic assemblage sub-block and the second hydraulic assemblage sub-block is formed at least in part from at least one of aluminum and an aluminum alloy.

20. The hydraulic assemblage as recited in claim 16, wherein the interlayer includes at least one adhesive as the at least one airtight material.

21. The hydraulic assemblage as recited in claim 16, further comprising:
at least one pump having at least one pump motor, the at least one pump being disposed at least one of on and in the second hydraulic assemblage sub-block.

22. The hydraulic assemblage as recited in claim 16, further comprising:
at least one control device disposed at least one of on and in the second hydraulic assemblage sub-block.

23. The hydraulic assemblage as recited in claim 16, wherein one of an input rod or pedal rod, to which a brake pedal is directly or indirectly linkable or linked, projects partly out of the first hydraulic assemblage sub-block.

24. The hydraulic assemblage as recited in claim 16, wherein a pedal travel sensor is disposed at least one of in and on the first hydraulic assemblage sub-block.

25. The hydraulic assemblage as recited in claim 16, wherein an adapter plate boltable onto a vehicle wall component of the respective vehicle is fastened on the first hydraulic assemblage sub-block.

26. The hydraulic assemblage as recited in claim 16, wherein at least one hydraulic linking structure, to which a brake fluid reservoir is hydraulically linkable or linked, is configured on an outer wall of the first hydraulic assemblage sub-block.

27. A braking system for a vehicle, the braking system including a hydraulic assemblage comprising:
a brake master cylinder; and
at least one valve;
wherein the brake master cylinder is disposed at least one of in and on a first hydraulic assemblage sub-block, and the at least one valve is disposed at least one of in and on a second hydraulic assemblage sub-block, the first hydraulic assemblage sub-block and the second hydraulic assemblage sub-block being joined to one another via an interlayer that is shaped at least in part from at least one airtight material having vibration-damping properties, and at least one first conduit portion of the first hydraulic assemblage sub-block being connected, via at least one hydraulic connecting structure extending through the interlayer, to at least one second conduit portion of the second hydraulic assemblage sub-block.

28. A manufacturing method for a hydraulic assemblage for a braking system of a vehicle, the method comprising:
forming a first hydraulic assemblage sub-block having a brake master cylinder at least partly surrounded by the first hydraulic assemblage sub-block;
forming a second hydraulic assemblage sub-block having at least one valve at least partly surrounded by the second hydraulic assemblage sub-block; and
configuring an interlayer, shaped at least in part from at least one airtight material having vibration-damping properties, by way of which the first hydraulic assemblage sub-block and the second hydraulic assemblage sub-block are joined to one another, in such a way that at least one first conduit portion of the first hydraulic assemblage sub-block becomes connected, via at least one hydraulic connecting structure extending through the interlayer, to at least one second conduit portion of the second hydraulic assemblage sub-block.

29. The manufacturing method as recited in claim 28, wherein a preform of the first hydraulic assemblage sub-block or the first hydraulic assemblage sub-block, and a preform of the second hydraulic assemblage sub-block or the second hydraulic assemblage sub-block, are over-molded, adhesively bonded, or vulcanized with the at least one airtight material.

30. The manufacturing method as recited in claim 28, wherein at least one initial form of the interlayer is formed from the at least one airtight material as a separate part, over which a preform of the first hydraulic assemblage sub-block or the first hydraulic assemblage sub-block, and a preform of the second hydraulic assemblage sub-block or the second hydraulic assemblage sub-block, are then joined to one another.
